(19) United States
(12) Patent Application Publication
(10) Pub. No.: US 2006/0002143 A1
(43) Pub. Date: Jan. 5, 2006

(54) Backlight unit of liquid crystal display device using light emitting diode and method of driving the same

(75) Inventors: Seung-Man Gu, Gyeongsangbukdo (KR); Kang-Ju Lee, Gyeongsangbukdo (KR)

Correspondence Address: HELLER EHRMAN WHITE & MCAULIFFE LLP, 1717 RHODE ISLAND AVE, NW, WASHINGTON, DC, 20036-3001, US

(73) Assignee: LG.PHILIPS LCD CO., LTD., Seoul (KR)

(21) Appl. No.: 11/149,277

(22) Filed: Jun. 10, 2005

(30) Foreign Application Priority Data
Jun. 29, 2004 (KR) 2004-0049518

(51) Int. Cl. F21V 7/04

(52) U.S. Cl. 362/612

(57) ABSTRACT

A liquid crystal display device includes a liquid crystal panel including first and second substrates facing each other, a liquid crystal layer between the first and second substrates, and a backlight unit having at least one optical film adjacent to the liquid crystal panel, a fluorescent lamp adjacent to the at least one optical film, and at least one set of three light emitting diodes adjacent to the fluorescent lamp.

The present invention claims the benefit of Korean Patent Application No. 2004-0049518 filed in Korea on Jun. 29, 2004, which is hereby incorporated by reference.

### BACKGROUND OF THE INVENTION

1. Field of the Invention

The present invention relates to a backlight unit of a display device, and more particularly, to a backlight unit of a liquid crystal display device using a light emitting diode and a method of driving the same.

2. Discussion of the Related Art

As the information age progresses, flat panel display (FPD) devices having light weight, thin profile, and low power consumption characteristics are being developed and commonly used as substitutes for cathode ray tube (CRT) devices. Generally, display devices can be classified according to their ability for self-emission, and may include emissive display devices and non-emissive display devices. The emissive display devices display images by taking advantage of their ability to self-emit light, and the non-emissive display devices require a light source since they do not emit light by themselves. For example, plasma display panel (PDP) devices, field emission display (FED) devices, and electroluminescent display (ELD) devices can be referred to as emissive display devices. On the other hand, liquid crystal display (LCD) devices may be categorized as non-emissive display devices LCD devices are commonly used in notebook and desktop computers because of their high resolution, capability of displaying color images, and high quality image display.

An LCD device includes an LCD panel for displaying images and a backlight unit for supplying light to the LCD panel. The LCD panel includes two substrates facing and spaced apart from each other, and a liquid crystal material interposed therebetween. Liquid crystal molecules of the liquid crystal material have a dielectric constant and refractive index anisotropic characteristics due to their long and thin shape. In addition, two electric field generating electrodes are formed on the two substrates. Accordingly, an orientation alignment of the liquid crystal molecules can be controlled by supplying a voltage to the two electrodes, wherein transmittance of the LCD panel is changed according to polarization properties of the liquid crystal material. However, since the LCD panel is a non-emissive-type display device, an additional light source is required. Thus, a backlight unit is disposed behind the LCD panel. The LCD device displays images using light produced by the backlight unit.

In general, backlight units may be classified into two types according to the disposition of a light source, such as a side-type and a direct-type. As display areas of the LCD devices become larger, direct-type backlight units including a plurality of light source have been commonly used in order to provide high brightness.

FIG. 1 is an expanded perspective view of an LCD device having a direct-type backlight unit according to the related art. In FIG. 1, an LCD device 10 includes an LCD panel 30, a direct-type backlight unit 20 under the LCD panel 30. First and second printed circuit boards 34a and 34b are disposed at first and second edges of the LCD panel 30, respectively. The direct-type backlight unit 20 includes a plurality of cold cathode fluorescent lamps (CCFLs) 24 spaced apart from each other, a reflector 22 under the CCFLs 24 and a plurality of optical films 26 between the LCD panel 30 and the plurality of CCFLs 24.

As explained above, when the LCD device 10 is applied to a large size television, discrimination for color-sensation in the large size television using an LCD device is very important. In other words, it is important how a phase on the screen is clearly shown. For example, a contrast ratio is a barometer to discern a clear phase. Here, because brightness of a black state is lower than brightness of a white state in general, a contrast ratio is highly affected by the brightness of the black state. Accordingly, the lower the brightness of black state is, the higher the contrast ratio is.

To overcome this problem, an adaptive brightness intensity (AI) type, which may continuously monitor signal conditions to maintain a high picture contrast, has been applied to the LCD device. More specifically, the AI type may be embodied to reduce the brightness in black state through a modulation of the backlight unit. However, when the AI type is applied to the LCD device, a boundary between a first phase and a second phase, which has a similar color-sensation to the first phase, is indistinct when the first phase overlaps the second phase. Consequently, it is difficult for the first and second phases to be distinguished from each other because the color sensation is depressed and the boundary between the first and second phases is indistinct. In other words when AI type is not applied to the LCD device, the boundary between the first and second phases is not indistinct although first and second phase have similar color sensations.

### SUMMARY OF THE INVENTION

Accordingly, the present invention is directed to a backlight unit of a liquid crystal display device using a light emitting diode and a method of driving the same that substantially obviate one or more of the problems due to limitations and disadvantages of the related art.

An object of the present invention is to provide a backlight of a liquid crystal display device using a light emitting diode that can produce a high image quality.

Another object of the present invention is to provide a method of driving a backlight unit of an LCD device that can produce a high image quality.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device includes a liquid crystal panel including first and second substrates facing each other, a liquid crystal layer between the first and second substrates, and a backlight unit having an optical film adjacent to the liquid crystal panel, a lamp adjacent to the optical film, and at least one set of three light emitting diodes adjacent to the lamp.

In another aspect of the present invention, a backlight unit for a display device includes a protection film adjacent to a display panel, first and second prism sheets adjacent to the protection film, a diffusion sheet adjacent to the first and second prism sheets, a lamp adjacent to the optical film, and at least one set of three light emitting diodes adjacent to the lamp.

In a further aspect of the present invention, a method of driving a backlight unit including a light emitting diode for a display device includes outputting a first image data from a micro processor including a memory and a processing unit processing the first image data as a second image data to distinguish two phases overlapping each other, converting the second image data into a third image data, and emitting red, green and blue colors in accordance with the third image data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is an expanded perspective view of an LCD device having a direct-type backlight unit according to the related art.

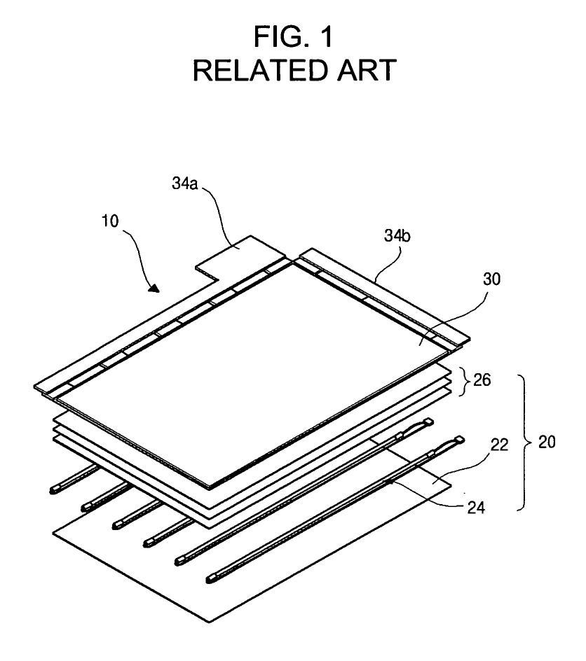

FIG. 2 is an expanded perspective view of an LCD device having a direct-type backlight unit using a light emitting diode according to an embodiment of the present invention.

FIG. 3 is a flow chart showing a driving method of a backlight unit using a light emitting diode for an LCD device according to an embodiment of the present invention.

FIG. 4 is a view showing an overlapped state of a first phase and a second phase having a similar color sensation to the first phase of a backlight unit of an LCD device using a light emitting diode according to an embodiment of the present invention.

### DETAILED DESCRIPTION OF THE PREFERRED EMBODIMENTS

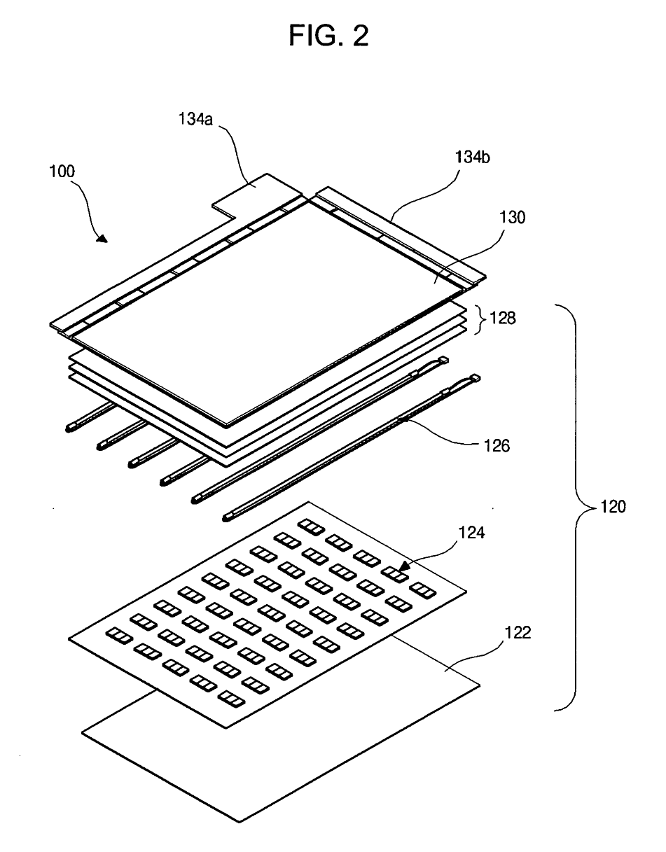

Reference will now be made in detail to the preferred embodiments of the present invention, examples of which are illustrated in the accompanying drawings. FIG. 2 is an expanded perspective view of an LCD device having a direct-type backlight unit using a light emitting diode according to the present invention.

In FIG. 2, an LCD device 100 includes an LCD panel 130 and a direct-type backlight unit 120 under the LCD panel 130. In addition, first and second printed circuit boards (PCBs) 134a and 134b are attached to first and second edges of the LCD panel 130, respectively. Although not shown, the LCD panel 130 includes a first substrate, a second substrate facing the first substrate and a liquid crystal (LC) layer interposed between the first and second substrates. For example, the first substrate has a gate line, a data line crossing the gate line, a thin film transistor electrically connected to the gate line and the data line, and a pixel electrode electrically connected to the thin film transistor, and the second substrate has a color filter layer. The LCD panel 130 is manufactured by attaching the first substrate and second substrate with the LC layer therebetween.

The backlight unit 120 includes a plurality of fluorescent lamps 126 spaced from each other and a plurality of optical films 128, such as a protection film, a prism sheet and a diffusion film. For example, the fluorescent lamp 126 may include a cold cathode fluorescent lamp.

A plurality of sets of light emitting diodes (LEDs) 124 spaced apart from each other are disposed adjacent to the plurality of fluorescent lamps 126 lighting the entire surface of the LCD panel 130. Each set of LEDs consists of three individual LEDs and each individual LED emitting one of three colors such as red, green and blue colors. The plurality of sets of light emitting diodes 124 may be formed on a transparent insulating substrate.

In addition, a reflector 122 is disposed adjacent to the plurality of light emitting diodes 124, thereby improving light efficiency. Here, the plurality of light emitting diodes 124 themselves can produce red, green and blue colors. Hereinafter, a driving feature of the light emitting diode 124 is more fully explained.

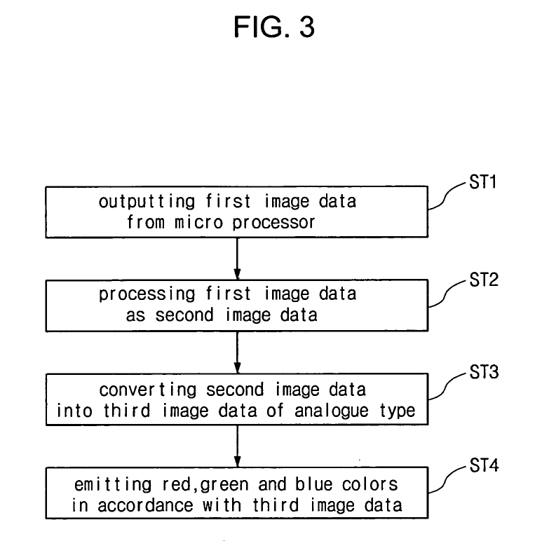

FIG. 3 is a flow chart showing a driving method of a backlight unit using a light emitting diode for an LCD device according to an embodiment of the present invention.

A first step (ST1) is to output a first image data from a micro processor including a memory and a processing unit. A step of analyzing color information and a position of the first image data may be additionally performed after the step of outputting the first image data.

In a second step (ST2), the first image data as a second image data is processed in order to distinguish two phases overlapped each other.

A third step (ST3) converts the second image data into a third image data of an analogue type.

In a fourth step (ST4), red, green and blue colors are emitted in accordance with the third image data of an analogue type.

In an embodiment of the present invention, the backlight unit may include a fluorescent lamp such as a cold cathode fluorescent lamp. When the light emitting diode is emitted through the above-explained steps, the LCD panel obtains a desired color-sensation by compensating through the above-steps. In other words, discrimination of two phases having a similar color-sensation to each other can be improved, thereby improving optional phases at any time.

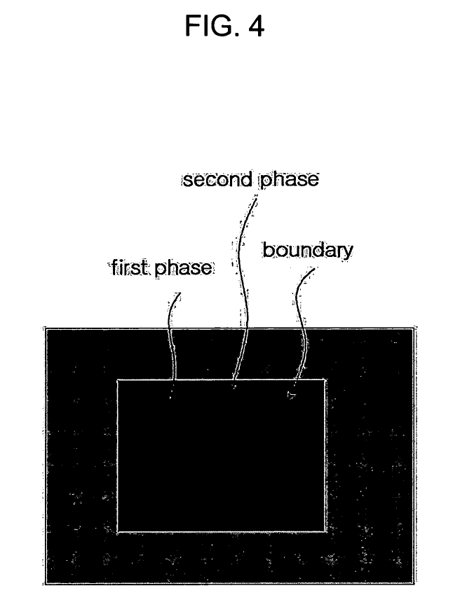

FIG. 4 is a view showing an overlapped state of a first phase and a second phase having a similar color sensation to the first phase of an LCD device using a light emitting diode as a backlight unit according to an embodiment of the present invention. As shown in FIG. 4, when the light emitting diode of the backlight unit is driven by the steps explained in FIG. 3, a boundary between a first phase and a second phase overlapped the first phase and having a similar color-sensation to the first phase can be distinguished because color brightness of the first and second phases is improved.

The LCD device, such as an adaptive brightness intensity (AI) type LCD television, according to an embodiment of the present invention can be manufactured so that it can have a high image quality. More specifically, the LCD device according to an embodiment of the present invention includes a light emitting diode emitting three colors as a backlight unit, discrimination of two phases can be improved in case that two similar phases are overlapped. As a result, the LCD device having a high image can be obtained in an embodiment of the present invention. The backlight unit of the present invention can be adaptive for any non-emissive display devices including liquid crystal display devices.

It will be apparent to those skilled in the art that various modifications and variations can be made in the backlight unit of a liquid crystal display device using a light emitting diode as and a method of driving the same of the present invention without departing from the spirit or scope of the invention. Thus, it is intended that the present invention cover the modifications and variations of this invention provided they come within the scope of the appended claims and their equivalents.

What is claimed is:

1. A display device, comprising:
a display panel; and
a backlight unit having an optical film adjacent to the liquid crystal panel, a lamp adjacent to the optical film, and at least one set of three light emitting diodes adjacent to the lamp.

2. The device according to claim 1, further comprising a reflector adjacent to the at least one set of three light emitting diodes.

3. The device according to claim 1, wherein the at least one optical film includes a protection film, first and second prism sheets, and a diffusion sheet.

4. The device according to claim 3, wherein the protection film is adjacent to the display panel, the first and second prism sheets are adjacent to the protection film, and the diffusion sheet is adjacent to the first and second prism sheets.

5. The device according to claim 1, wherein each of the at least one set of three light emitting diodes emits red, green and blue colors, respectively, and the at least one set of three light emitting diodes is substantially uniformly positioned over an entire surface of the liquid crystal panel.

6. The device according to claim 1, wherein the lamp includes a cold cathode fluorescent lamp.

7. The device according to claim 1, wherein the backlight unit includes a direct-type.

8. The device according to claim 1, wherein the at least one set of three light emitting diodes is formed on a transparent insulating substrate.

9. The device according to claim 1, wherein the display device includes a liquid crystal display device.

10. A backlight unit of a display device, comprising;
a protection film adjacent to a display panel;
first and second prism sheets adjacent to the protection film;
a diffusion sheet adjacent to the first and second prism sheets;
a lamp adjacent to the optical film; and
at least one set of three light emitting diodes adjacent to the lamp.

11. The backlight unit according to claim 10, further comprising a reflector adjacent to the at least one set of three light emitting diodes.

12. The backlight unit according to claim 10, wherein each of the at least one set of three light emitting diodes emits red, green and blue colors, respectively, and the at least one set of three light emitting diodes is substantially uniformly positioned over an entire surface of the display panel.

13. The backlight unit according to claim 10, wherein the lamp includes a cold cathode fluorescent lamp.

14. The backlight unit according to claim 10, wherein the backlight unit includes a direct-type.

15. The back light unit according to claim 10, wherein the at least one set of three light emitting diodes is formed on a transparent insulating substrate.

16. A method of driving a backlight unit including a light emitting diode for a display device, comprising:
outputting a first image data from a micro processor including a memory and a processing unit;
processing the first image data as a second image data to distinguish two phases overlapping each other;
converting the second image data into a third image data; and
emitting red, green and blue colors in accordance with the third image data.

17. The method according to claim 16, further comprising analyzing a color information and a position of the first image data before the processing the first image data.

18. The method according to claim 16, wherein the third data is an analogue type.

19. The method according to claim 16, wherein the backlight unit includes a lamp.

20. The method according to claim 19, wherein the lamp includes a cold cathode fluorescent lamp.

21. The method according to claim 16, wherein the display device includes a liquid crystal display device.
